(19) United States
(12) Patent Application Publication
(10) Pub. No.: US 2016/0142486 A1
(43) Pub. Date: May 19, 2016

(54) DATA-ACCESS SYSTEM AND METHOD FOR STORING DATA AND READING DATA

(71) Applicant: Quanta Computer Inc., Taoyuan City (TW)

(72) Inventors: Tien-Chin Fang, Taoyuan City (TW); Chen-Chung Lee, Taoyuan City (TW); Ping-Chi Lai, Taoyuan City (TW); Chia-Hung Lin, Taoyuan City (TW); Ming-Jen Chen, Taoyuan City (TW); Ching-Wen Lin, Taoyuan City (TW); Chun-He Lin, Taoyuan City (TW)

(21) Appl. No.: 14/596,386

(22) Filed: Jan. 14, 2015

(30) Foreign Application Priority Data
Nov. 14, 2014 (TW) 103139492

(51) Int. Cl. H04L 29/08; H04L 12/26

(52) U.S. Cl. CPC H04L 67/1097; H04L 43/0805

(57) ABSTRACT

A data-access system, adapted to a plurality of Cloud storage providers, including a processing module, an access module and a storage module. The processing module receives a file, and obtains a dismantling rule according to file information. The processing module further dismantles the file into a plurality of sub-files according to a storage signal and the dismantling rule. The access module respectively detects the status of the connection of the Cloud storage providers, and the sub-files are stored to at least two of the Cloud storage providers according to the connections statuses. The storage module stores the dismantling rule and the storage records correspond to the sub-files.

### CROSS REFERENCE TO RELATED APPLICATIONS

This Application claims priority of Taiwan Patent Application No. 103139492, filed on Nov. 14, 2014, the entirety of which is incorporated by reference herein.

### BACKGROUND OF THE INVENTION

1. Field of the Invention

The application relates in general to a data-access system and method for storing data and reading data, and in particular to a data-access system and method for storing data and reading data for dismantling the file into a plurality of sub-files, and further storing the sub-files to different Cloud storage providers for improving the access efficiency and security of the file.

2. Description of the Related Art

These days, due to the rapid development of the Internet, users are able to access files held by Cloud storage providers using different electronic devices. Access speed is affected by the connection status and the size of the file, due to the different characteristics of the Cloud storage providers. For example, access time might be too long when the connection status is unstable or the size of the file is too large. Otherwise, the file might be stolen when it is only stored in a single Cloud storage provider. Thus, how to access the file from the Cloud storage providers rapidly and safely is a problem which needs to be solved immediately.

### BRIEF SUMMARY OF INVENTION

An embodiment of the present invention provides a data-access system, adapted to a plurality of Cloud storage providers, including a processing module, an access module and a storage module. The processing module receives a file, and obtains a dismantling rule according to file information. The processing module further dismantles the file into a plurality of sub-files according to a storage signal and the dismantling rule. The access module detects the status of the connection of each Cloud storage providers, and the sub-files are stored to at least two of the Cloud storage providers according to the connections statuses. The storage module stores the dismantling rule and the storage records correspond to the sub-files.

Another embodiment of the present invention provides a method for storing data, adapted to a plurality of Cloud storage providers. The steps comprise: receiving a file and a storage signal; obtaining a dismantling rule according to information in the file; dismantling the file into a plurality of sub-files according to the dismantling rule; detecting the connection status of each Cloud storage provider; storing the sub-files to the Cloud storage providers randomly according to the status of the connection; and storing to a storage module the dismantling rule and a storage record corresponding to the sub-files.

Another embodiment of the present invention provides a method for reading data, adapted to a plurality of Cloud storage providers, the steps comprise: receiving a reading signal; reading a storage record of a file that corresponds to the reading signal; detecting the status of the connection of each Cloud storage provider; reading a plurality of sub-files from the Cloud storage providers according to the status of the connection and the storage record; combining the sub-files into the file according to a dismantling rule corresponding to the file; and displaying the file on a display module by an application.

### BRIEF DESCRIPTION OF DRAWINGS

The invention can be more fully understood by reading the subsequent detailed description and examples with references made to the accompanying drawings, wherein:

FIG. 1 is a block diagram of a data-access system in accordance with an embodiment of the invention;

FIG. 2 is a flow chart of a method for storing data in accordance with an embodiment of the invention;

FIG. 3 is a flow chart of a method for reading data in accordance with an embodiment of the invention.

### DETAILED DESCRIPTION OF INVENTION

Further areas to which the present systems and methods can be applied will become apparent from the detailed description provided herein. It should be understood that the detailed description and specific examples, while indicating exemplary embodiments of the data-access system and method for storing data and reading data, are intended for purposes of illustration only and are not intended to limit the scope of the invention.

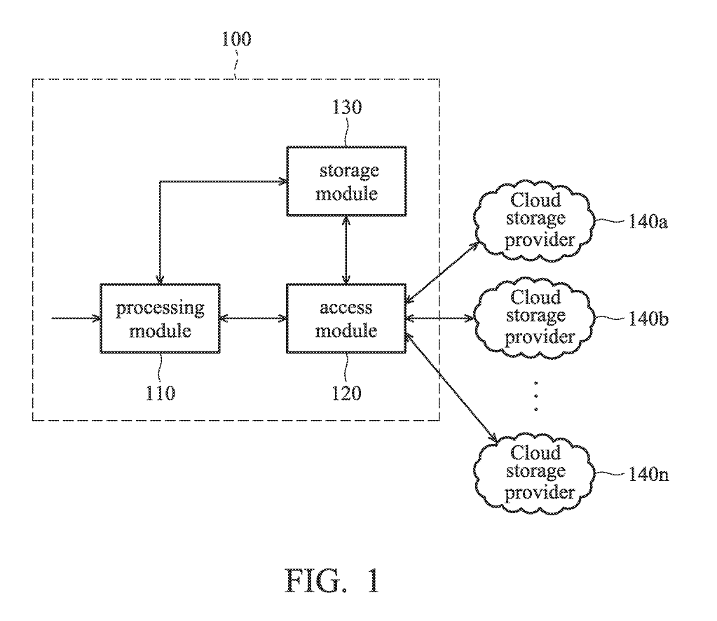

Please refer to FIG. 1. FIG. 1 is a block diagram of a data-access system in accordance with an embodiment of the invention. As shown in FIG. 1, the data-access system 100, adapted to a plurality of Cloud storage providers 140a˜140n, includes a processing module 110, an access module 120 and a storage module 130. The Cloud storage providers include Dropbox, Google Drive, iCloud, etc. The processing module 110 receives a file, obtains a dismantling rule according to file information, and dismantles the file into a plurality of sub-files according to a storage signal and the dismantling rule, or combines the sub-files into the file according to a reading signal and the dismantling rule. The access module 120 detects the respective status of the connection of each Cloud storage provider, and randomly stores the sub-files to at least two of the Cloud storage providers 140a˜140n according to the connections statuses, or reads the sub-files from at least two of the Cloud storage providers 140a˜140n, and sends the read sub-files back to the processing module 110 for combination. The storage module 130 stores the dismantling rule, and the storage records of the sub-files after the sub-files are randomly stored to at least two of the Cloud storage providers 140a˜140n. It should be noted that the data-access system 100 further includes a display module (not shown), which is used to display the file by an application.

According to an embodiment of the present invention, when the processing module 110 receives the file and the storage signal, it stores the file into the plurality of Cloud storage providers 140a˜140n according to the dismantling rule. For example, the processing module 110 determines the quantity of dismantling and the quantity of copies of the files, and the quantity of sub-files stored in the Cloud storage providers 140a˜140n according to the size or the type of the file. The processing module 110 obtains an optimal dismantling rule according to a dismantling rule table stored in the storage module 130. The processing module 110 further obtains a risk score ((risk score)=(original risk score)/(quantity of dismantling)/(quantity of copies of files)/(quantity of Cloud storage providers)) according to a function, or users can determine a new risk score by resetting the parameters as described above after obtaining the risk score. In general, the larger the file size, the higher the importance. In other words, the higher the quantity of copies of the files, the quantity of dismantling and the quantity of the sub-files stored in the Cloud storage providers 140a˜140n, the lower the risk. After obtaining the parameters corresponding to the dismantling rule, the processing module 110 dismantles the file into the plurality of the sub-files according to the new risk score.

Then, the access module 120 detects the respective status of the connection of the Cloud storage providers 140a˜140n. The connection status can be regarded as the connection status between the data-access system and the Cloud storage providers 140a˜140n. After obtaining the status of the connection between the data-access system and the Cloud storage providers 140a˜140n, the access module 120 randomly stores the sub-files to at least two of the Cloud storage providers 140a˜140n according to the connection status. The storage module 120 further stores the sub-files to different Cloud storage providers 140a˜140n according to the quality of the connection status. For example, the storage module 120 stores the sub-files to three of the Cloud storage providers which have the fastest connection speed or the biggest spaces, but it is not limited thereto. After the storage module 120 stores the sub-files, the storage records corresponding to the sub-files are stored to the storage module 130 for supplying to the processing unit 110 for finding the storage address of each sub-files while the files are processed to read, browse or delete.

It should be noted that the sub-files or the process of dismantling can be encrypted by an encryption key when the processing module 110 dismantles the files to the plurality of sub-files according to the dismantling rule for reducing the risk and improving the security of the file.

According to another embodiment of the present invention, the processing module 110 combines the sub-files into the original file when it receives the reading signal. First, after receiving the reading signal, the access module 120 detects the status of the connection of the Cloud storage providers 140a˜140n. Then the access module 120 reads the sub-files from the Cloud storage providers 140a˜140n according to the status of the connection and the storage records. The access module 120 further reads the sub-files according to the quality of the status of the connection. For example, the access module 120 reads the sub-files from three of the Cloud storage providers which have the fastest connection speed or the biggest spaces. After receiving the sub-files, the processing module 110 combines the sub-files into the original file according to the dismantling rule stored in the storage module 130, and the original file will be displayed on the display module (not shown) by the application.

It should be noted that the user needs to enter the encryption key when the sub-files are encrypted and combined into the original file by the processing module 110.

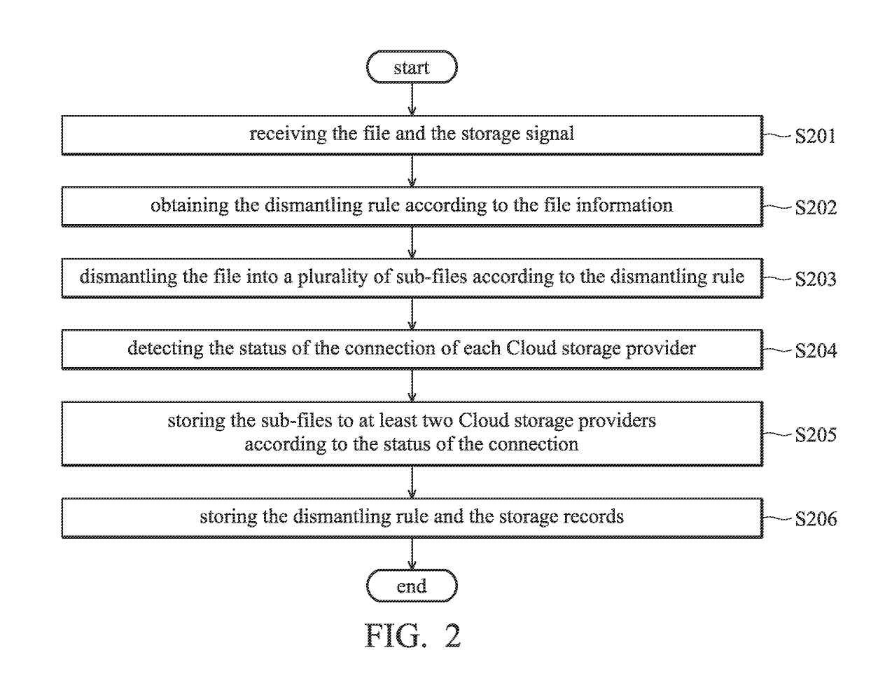

Please refer to FIG. 2 with FIG. 1. FIG. 2 is a flow chart of a method for storing data in accordance with an embodiment of the invention. First, at step S201, the processing module 110 receives the file and the storage signal. At step S202, the processing module 110 obtains the dismantling rule according to the file information. The file information includes the size of the file and the type of the file, etc. The dismantling rule includes the quantity of dismantling and the quantity of copies of the files, and the quantity of the sub-files stored in the Cloud storage providers 140a˜140n. The larger the file size, the higher the importance. In other words, the more the quantity of copies of the files, the quantity of dismantling and the quantity of the sub-files stored in the Cloud storage providers 140a˜140n, the lower the risk. For example, the greater the quantity of dismantling, the lower the risk of being stolen. The processing module 110 still can read the sub-files from different Cloud storage providers 140a˜140n when the status of the connection of some of the Cloud storage providers are not stable due to the large number of copies. The processing module 110 obtains the optimal dismantling rule according to the dismantling rule table stored in the storage module 130. The processing module 110 further obtains a risk score ((risk score)=(original risk score)/(quantity of dismantling)/(quantity of copies of the files)/(quantity of Cloud storage providers)) according to a function. For example, before the file is dismantled, the size of the file is 10M byte, and the original risk score is 4 (i.e. the larger the file size, the higher the risk score). The processing module 110 dismantles the file into two sub-files, one copy of the file, and stores the sub-files to the Cloud storage provider 140a and 140b, and the renew risk score is 1, which means the risk is reduced after dismantling the file. It should be noted that the parameter can be set by the user, and the dismantling rule will be renewed, but it is not limited thereto.

At step S203, the processing module 110 dismantles the file into a plurality of sub-files according to the dismantling rule. At step S204, the access module 120 detects the status of the connection of the Cloud storage providers 104a˜140n. At step S205, the access module 120 randomly stores the sub-files to at least two Cloud storage providers 104a˜140n according to the status of the connection. The connection status can be regarded as the connection status between the data-access system and the Cloud storage providers 140a˜140n. For example, the processing module 110 dismantles the file into a first sub-file, a second sub-file and a third sub-file, and the quantity of the copies is “2”. Then the access module stores the sub-files to a first Cloud storage provider 140a, a second Cloud storage provider 140b and a third Cloud storage provider 140c, which means each of the Cloud storage providers includes two different sub-files. For example, the first Cloud storage provider 140a includes the first sub-file and the second sub-file, the second Cloud storage provider 140b includes the first sub-file and the third sub-file, and the third Cloud storage provider 140c includes the second sub-file and the third sub-file. As result, the access module 120 can read the sub-files from any of two Cloud storage providers and combines the sub-files to the original file when the user wants to read the file.

It should be noted that the storage module 120 further stores the sub-files to different Cloud storage providers 140a˜140n according to the quality of the connection status. For example, the storage module 120 stores the sub-files to the most three Cloud storage providers which have the fastest connection speed or the spaces, but it is not limited thereto. Finally, at step S206, the storage module stores the dismantling rule and the storage records corresponding to the sub-files.

It should be noted that the sub-files, or the process of dismantling, can be encrypted by an encryption key when the processing module 110 dismantles the files to the plurality of sub-files according to the dismantling rule for reducing the risk and improving the security of the file.

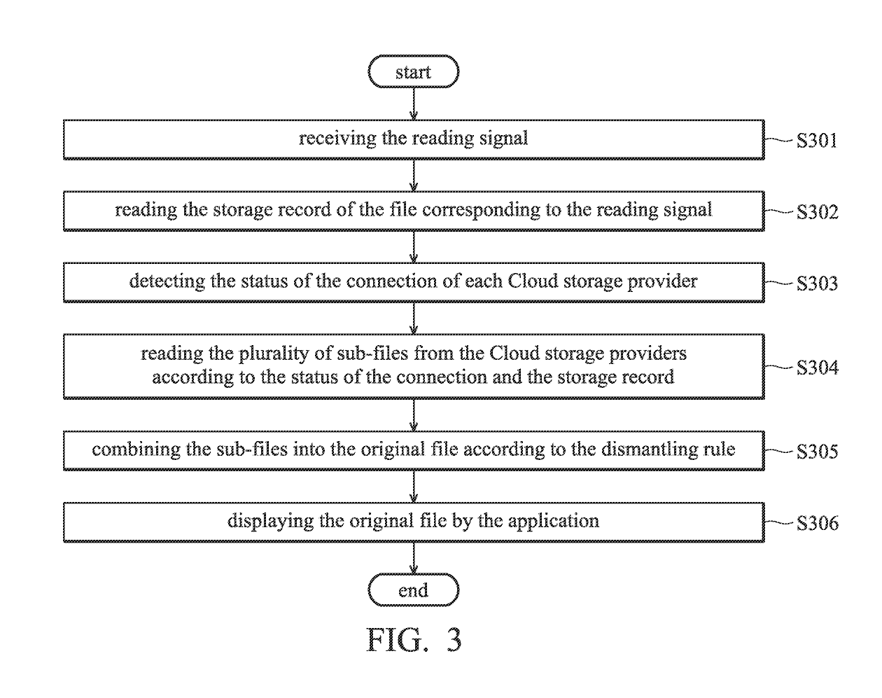

Please refer to FIG. 3 with FIG. 1. FIG. 3 is a flow chart of a method for reading data in accordance with an embodiment of the invention. At step S301, the processing module 110 receives the reading signal. At step S302, the processing module 110 reads the storage record of the file corresponding to the reading signal. At step S303, the access module 120 detects the status of the connection of the Cloud storage providers 140a˜140n. The connection status can be regarded as the connection status between the data-access system and the Cloud storage providers 140a˜140n. At step S304, the access module 120 reads the plurality of sub-files from the Cloud storage providers 140a˜140n according to the status of the connection and the storage record. The access module 120 further reads the sub-files according to the quality of the status of the connection. For example, the access module 120 reads the sub-files from three of the Cloud storage providers which have the fastest connection speed or the biggest spaces. At step S305, the processing module 110 combines the sub-files into the original file according to the dismantling rule. Finally, at step S306, the original file is displayed on a display module by the application.

It should be noted that the users need to enter the encryption key when the sub-files are encrypted and proceeded to combine into the original file by the processing module 110.

As described above, an embodiment of the invention provides a data-access system and method for storing data and reading data, users can store the sub-file to different Cloud storage providers by dismantling the file into the plurality of sub-files for successfully accessing the file when the status of the connection of the Cloud storage providers are not stable. Further, the user can encrypt the sub-files during the dismantling process to improve the security of the file, and hackers cannot obtain the original file from a single Cloud storage provider.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. A data-access system, adapted to a plurality of Cloud storage providers, comprising:
a processing module, receiving a file, obtains a dismantling rule according to information in the file, and dismantles the file into a plurality of sub-files according to a storage signal and the dismantling rule;
an access module, detecting status of the connection of the Cloud storage providers respectively, stores the sub-files to at least two of the Cloud storage providers according to the connections statuses; and
a storage module, storing the dismantling rule and storage records that correspond to the sub-files.

2. The data-access system as claimed in claim 1, wherein the storage module reads the sub-files according to a reading signal and the storage records, and the data-access system combines the sub-files into the file according to the dismantling rule.

3. The data-access system as claimed in claim 1, wherein the dismantling rule comprises quantity of dismantling and quantity of copies of the files, and quantity of the sub-files stored in the Cloud storage providers.

4. The data-access system as claimed in claim 1, wherein the storage module further stores login information of the Cloud storage providers.

5. A method for storing data, adapted to a plurality of Cloud storage providers, comprising:
receiving a file and a storage signal;
obtaining a dismantling rule according to information in the file;
dismantling the file into a plurality of sub-files according to the dismantling rule;
detecting status of the connection of the Cloud storage providers;
storing the sub-files to the Cloud storage providers randomly according to the status of the connection; and
storing the dismantling rule and a storage record corresponding to the sub-files to a storage module.

6. The method for storing data as claimed in claim 5, wherein the dismantling rule comprises quantity of dismantling and quantity of copies of the files and quantity of the sub-files stored in the Cloud storage providers.

7. The method for storing data as claimed in claim 5, further comprising:
encrypting the sub-files according to an encryption key.

8. A method for reading data, adapted to a plurality of Cloud storage providers, comprising:
receiving a reading signal;
reading a storage record of a file correspond to the reading signal;
detecting status of the connection of the Cloud storage providers;
reading a plurality of sub-files from the Cloud storage providers according to the status of the connection and the storage record;
combining the sub-files into the file according to a dismantling rule corresponding to the file; and
displaying the file on a display module by an application.

9. The method for reading data as claimed in claim 8, further comprising:
obtaining the dismantling rule according to information in the file, wherein the dismantling rule comprises quantity of dismantling and quantity of copies of the files, and quantity of the sub-files stored in the Cloud storage providers.

10. The method for reading data as claimed in claim 8, further comprising:
decrypting the sub-files according to an encryption key.
